(19) United States
(12) Patent Application Publication
(10) Pub. No.: US 2022/0178302 A1
(43) Pub. Date: Jun. 9, 2022

(54) GAS TURBINE APPARATUS WITH COUNTER-ROTATING BLADES

(71) Applicant: Jay HASKIN, Bryan, TX (US)

(72) Inventor: Jay HASKIN, Bryan, TX (US)

(21) Appl. No.: 17/113,995

(22) Filed: Dec. 7, 2020

(51) Int. Cl. F02C 3/067; F02C 7/264; F02C 7/22; F02C 7/06

(52) U.S. Cl. CPC F02C 3/067; F02C 7/264; F02C 7/22; F05D 2260/99; F05D 2240/50; F05D 2240/60; F02C 7/06

(57) ABSTRACT

A gas turbine apparatus has a main shaft, a first plurality of blades mounted to the main shaft, a second plurality of blades each interposed between blades of the first plurality of blades, a barrel affixed to the second set of blades, a fuel line opening to an interior of the barrel, and an igniter cooperative with the interior of the barrel and adapted to selectively ignite fuel in the barrel. The first plurality of blades rotate in a direction opposite to a direction of rotation of the second plurality of blades. The fuel line passes a fuel into the interior of the barrel.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to turbines having counter-rotating blades. More particularly, the present invention the relates to gas turbines.

### 2. Description of Related Art Including Information Disclosed Under 37 CFR 1.97 and 37 CFR 1.98

A gas turbine, also called a combustion turbine, is a type of continuous and internal combustion engine. The main elements, to all gas turbines, are an upstream rotating gas compressor, a combustor, and a downstream turbine on the same shaft as the compressor. A fourth component is often used increase efficiency to convert power into a mechanical or an electrical form or to achieve a greater thrust-to-weight ratio.

The basic operation of the gas turbine is a Brayton cycle with air as the working fluid. Atmospheric air flows through the compressor that brings it to a higher pressure. Energy is then added by spraying fuel into the air and igniting it so that the combustion generates a high-temperature flow. This high-temperature pressurized gas enters the turbine so as to produce a shaft work output in the process. This is used to drive the compressor. The unused energy comes out in the exhaust gases that can be repurposed for external work, such as directly producing thrust in a combined cycle engine, or rotating a second independent turbine (known as a power turbine) that can be connected to a fan, a propeller, or an electrical generator. The purpose of the gas turbine determines the design so that the most desirable split of energy between the thrust and the shaft work is achieved. Gas turbines are often used to power drone aircraft, trains, ships, electrical generators, pumps, gas compressors and tanks.

The present inventor has extensive experience in the field of turbines that utilize counter-rotating blades. For example, U.S. Pat. No. 9,410,430, issued on Aug. 9, 2016 to the present inventor, describes turbine apparatus with counter-rotating blades. This turbine apparatus has a main shaft, a first set of blades mounted to the main shaft, a second set of blades, and a barrel affixed to a periphery of the second set of blades. The barrel is rotatably mounted independent of rotation of the main shaft. The barrel and the second set of blades rotate in a direction opposite to the direction of rotation of the first set of blades and the main shaft. A third set of blades is mounted to the main shaft such that the second set of blades is interposed between the first and third sets of blades. An outer shell extends over an outer surface of the barrel such that the barrel is rotatable interior of the outer shell.

U.S. Pat. No. 10,260,367, issued on Apr. 16, 2019, to the present inventor, teaches a power transmission for a turbines or compressors having counter-rotating blades. This power transmission has a housing, a first shaft rotatably mounted so as to be rotatable in one direction in the housing, a barrel rotatably mounted so as to be rotatable in a direction opposite to that of the first shaft within the housing, a first plurality of blades affixed to the first shaft and extending radially outwardly therefrom, and a second plurality of blades affixed to the barrel and extending inwardly therefrom. Each blade of the second plurality of blades is interposed between adjacent blades of the first plurality of blades. A second shaft is mounted exterior of the housing so as to drive the barrel in rotation.

U.S. Pat. No. 10,190,436, issued on Jan. 29, 2019 to the present inventor, teaches a power transmission system for a turbine, a turbocompressor, a compressor, or a pump having counter-rotating blades. This power transmission system includes a housing, a first shaft mounted within the housing, a second shaft rotatably mounted within the housing and positioned exterior of the first shaft, a second set of blades affixed to the first shaft, and a second set of blades affixed to the second shaft. The first set of blades is positioned adjacent to the second set of blades. The first set of blades is rotatable in a direction opposite to the second shaft and the second set of blades. A power receiver is driven by the second shaft so as to convert rotational energy of the second shaft into energy or motion.

U.S. Pat. No. 9,745,860, issued on Aug. 29, 2017 to the present inventor describes a power transmission system for a turbine or compressor having counter-rotating blades. This power transmission apparatus has a housing, a first shaft rotatably mounted within the housing, a second shaft rotatably mounted within the housing and extending around at least a portion of the first shaft, a third shaft exterior of the first and second shaft and positioned within the housing, a first transmission connected to the second shaft and to the third shaft such that a rotation of the second shaft causes rotation of the third shaft, a second transmission connected to the first shaft and to the third shaft such that a rotation of the first shaft applies rotational energy to the third shaft, and a power receiver connected to the third shaft so as to convert the rotational energy of the third shaft into energy or motion.

In the past, various patents have issued relating to such turbines. For example, U.S. Pat. No. 4,648,788, issued on Mar. 10, 1987 to P. Jochum, describes a device and a fluid pressure generator that includes an annular casing which is peripherally mounted and driven in a through-flow channel. The interface of the annular casing forms part of the wall of the through-flow channel. The annular casing is provided with a number of propeller blades which extend radially inwardly into the through-flow channel and which are rotationally mounted on their individual pin shafts by means of which the magnitude of the thrust may be altered in a continuous manner and the direction of the operation of the thrust can be reset.

U.S. Pat. No. 4,969,325, issued on Nov. 13, 1992 to Adamson et al., shows a turbofan engine having a counter-rotating partially-geared fan drive turbine. This turbofan engine has a fan section, a booster compressor disposed aft of the fan section relative to the flow of combustion gases through the engine, and a core section disposed aft the booster compressor. A low-pressure counterrotating turbine, disposed aft the core section, is used for driving the fans section and the booster compressor. The counterrotating turbine includes at least one set of rotating turbine blades and at least one set of oppositely rotating counterrotating turbine blades. A twin spool shaft is provided for coupling the turbine blades to the booster compressor and for coupling the counterrotating turbine blades to the fans section.

U.S. Pat. No. 6,278,197, issued on Aug. 21, 2001 to K. Appa, discloses a contra-rotating wind turbine system. A hub assembly is provided having inner and outer coaxial shafts telescopically related but radially spaced to permit independent rotation about a generally horizontal axis. A first set of rotor blades is mounted on the inner shaft at a plurality of circumferentially-spaced locations. The rotor blades extend radially away from the axis of rotation and positioned on the inner shaft for rotating the inner shaft in a first direction about the axis of rotation when subjected to wind-induced airflow. A second set of rotor blades is similarly mounted on the outer shaft axially spaced from the first set of rotor blades for rotating the outer shaft about the axis of rotation in an opposite direction.

U.S. Pat. No. 7,195,446, issued a Mar. 27, 2007 to Seda et al., provides a counter-rotating turbine engine that provides a low-pressure turbine inner rotor configured to rotate in a first direction and a low-pressure turbine outer rotor configured to rotate in a second direction that is opposite to the first rotational direction. At least one foil bearing is coupled to at least one of the inner and outer rotors so as to improve clearance control between a first rotating component and at least one of a second rotating component and a non-rotating component.

U.S. Pat. No. 7,290,386, issued on Nov. 6, 2007 to Orlando et al., teaches a counter-rotating gas turbine engine. A low-pressure turbine inner rotor includes a first plurality of turbine blade rows configured to rotate in a first direction and a low-pressure turbine outer rotor rotatably coupled to the inner rotor. The outer rotor includes a second plurality of turbine blade rows that are configured to rotate in a second direction that is opposite the first rotational direction of the inner rotor such that at least one of the second plurality of turbine blade rows is coupled axially forward of the first plurality of turbine blade rows.

U.S. Pat. No. 7,451,592, issued on Nov. 18, 2008 to Taylor et al., teaches a counter-rotating turbine engine which includes a gearbox. The turbine engine arrangement is provided with contra-rotating shafts and a gearbox which is also coupled to a shaft. The relative rotational speed ratio between the shafts can be determined with a first low-pressure turbine secured to the first shaft arranged to rotate at a lower speed but provide high work whilst a second low-pressure turbine secured to the second shaft rotates at a higher speed governed by the gearbox.

U.S. Pat. No. 8,393,853, issued on Mar. 12, 2013 to Sauer et al., provides a high-efficiency turbine and method of generating power. The turbine includes a plurality of blades that rotate in a single direction when exposed to a fluid flow. The plurality of blades are joined to the central shaft by a plurality of radial spokes disposed substantially perpendicular to the central shaft such that the rotating plurality of blades causes the shaft to rotate.

U.S. Patent Publication No. 2012/0049523, published on Mar. 1, 2012 to S. A. Bersiek, describes a wind jet turbine with fan blades located on an inner and outer surface of the cylinder so as to allow wind or liquid to pass through the inner and outer blades. The wind jet turbine has a first set of fan blades, a plurality of magnets that each has a magnetic field, a cylinder having an inside and outside surface that supports the first set of fan blades on the inside surface and coupled to the plurality of magnets, and at least one cable winding located apart from the magnets. The rotation of the cylinder results in the movement of the magnetic field across at least one cable winding.

U.S. Patent Publication No. 2013/0219859, published in Aug. 29, 2013 to Suciu et al., provides a counter-rotating low-pressure compressor and turbine. The compressor section includes a counter-rotating low-pressure compressor that includes outer and inner compressor blades interspersed with one another and configured to rotate in opposite directions to one another about an axis of rotation. A transmission couples at least one of the outer and inner compressor blades to a shaft. The turbine section includes a counter-rotating low-pressure turbine having an outer rotor that includes an outer set of turbine blades. An inner rotor has an inner set of turbine blades interspersed with the outer set of turbine blades. The outer rotor is configured to rotate in an opposite direction about the axis of rotation from the inner rotor. A gear system couples at least one of the outer and inner rotors to the shaft.

U.S. Patent Publication No. 2013/0230380, published on Sep. 5, 2013 to Allouche et al., discloses a rotating housing turbine. The housing has a side wall. The turbine blades are attached to the side wall. The turbine is completely open in the center so as to allow a space for solids and debris to be directed out of the turbine without jamming the spinning blades/side wall.

Referring to FIG. 1, there shown the turbine apparatus 10 in accordance with U.S. Pat. No. 9,410,430 of the present inventor. The turbine apparatus 10 includes a first set of blades 12, a second set of blades 14, a main shaft 16, a barrel 18, and an outer shell 20. In FIG. 1, it can be seen that the first set of blades 12 is directly mounted to the main shaft 14. The second set of blades 14 is directly mounted, at a periphery thereof, to the barrel 18. The main shaft 16 extends centrally through the first set of blades 12 and the second set of blades 14. The main shaft 16 is not connected to the second set of blades 14. In the preferred embodiment the present invention, the second set of blades 14 will rotate in a direction opposite to the second set of blades 12 and to the direction of rotation of the main shaft 16. As a result, the barrel 18 will rotate in a direction opposite to the rotation of the main shaft 16.

In FIG. 1, it can be seen that there is a third set of blades 22 that is affixed to the main shaft 16. The third set of blades 22 extends in generally parallel relationship to the first set of blades 12. The second set of blades 14 is positioned between the first set of blades 12 and the second set of blades 14. There is a fourth set of blades 24 that is mounted, at the periphery thereof, to the barrel 18. As such, when the first of blades 12 and the third set of blades 22 rotate with the rotation of the main shaft 16, the second set of blades 14 and the fourth set of blades 24 will rotate in the opposite direction. The odd numbered sets of blades will rotate in an opposite direction to that of the even-numbered sets of blades.

A fluid inlet 26 is directed toward the first set of blades 12 within the interior of the barrel 18. The fluid inlet 26 includes a nozzle 28 for directing the fluid into the interior of the barrel 18 and toward the first set of blades 12. The injection of the fluid through the fluid inlet 26 will impart rotational movement to the first set of blades 12. The direction of the blades within the first set of blades 12 will impart an opposite directional movement to the second set of blades 14 such that the barrel 18 will rotate in the opposite direction. The orientation of the blades of the second set of blades 14 will be directed to the third set of blades 22 so as to further direct rotational energy toward the third set of blades 22. Similarly, the orientation of the blades in the third set of blades 22 is directed to the fourth set of blades 24 so as to further enhance the torque applied by the fourth set of blades 24 to the barrel 18.

The shaft 16 is mounted within bearings and supported by a bearing pedestal 30. The bearing pedestal 30 can be supported upon an underlying surface, such as a floor. The bearing supports the main shaft 16 in a rotatable configuration. The rotatable shaft 16 can extend for use exterior of the turbine apparatus 10. For example, the main shaft 16 can extend so as to be linked to a power source, such as an electrical generator, a boiler feed pump, a compressor, a water pump, a hydraulic unit, or other systems that can utilize rotational energy.

The outer shell 20 extends around the exterior of the barrel 18. As such, the interior of the outer shell 20 is sufficiently sealed so as to avoid loss of pressurized fluid and friction with exterior elements.

The rotating barrel 18 can be suitably coupled to allow for the rotation of another shaft or to facilitate the rotation of the main shaft 16. For example, the rotating barrel 18 can be coupled by a gear arrangement to another shaft located adjacent to the main shaft 16. Alternatively, a planetary gear arrangement can be coupled between the barrel 18 and the main shaft 16 such that rotational energy of the barrel 18 can be delivered to the main shaft. Still further and alternatively, various rollers, or other connecting devices, can be coupled to the barrel 18 such that the rotating energy of the barrel 18 can be delivered for external use.

FIG. 2 shows still another embodiment of the turbine with counter-rotating blades of the prior art and, in particular, of U.S. Pat. No. 9,410,430 of the present inventor. FIG. 2 shows an embodiment in the form of a gas compressor 40. In FIG. 2, the gas compressor 40 includes the main shaft 42, the first set of blades 43, the second set of blades 44, the third set of blades 46 and the fourth set of blades 48. The first and third sets of blades will rotate in the same direction. The second and fourth sets of blades will rotate in the opposite direction. The barrel 50 is affixed to the second set of blades 44 and the fourth set of blades 48. As a result, the barrel 50 will rotate in opposite direction to that of the main shaft 42.

FIG. 2, shows, in particular, the fluid inlet 52. In FIG. 2, fluid is delivered through the interior of a manifold 54 and directed toward the sets of blades 43, 44, 46 and 48. As such, this fluid, such as a gas, will cause the respective rotation of the main shaft 42 and the barrel 50. There is an exhaust outlet 56 positioned at the end of the array of blades. As such, the gas can be properly discharged. An outer shell 58 is provided over the exterior of the barrel 50 for pressure considerations. As such, the fluid can flow through the space between the outer shell 58 and the barrel 50 if the pressure should become too great.

In FIG. 2, it can be seen that the shaft 42 is affixed to a bearing pedestal 60 at one end thereof. The shaft 42 is connected to a power source 62 at an opposite end thereof. A planetary gear arrangement 64 is illustrated as coupling the barrel 52 to the shaft 42. Alternatively, various other types of gearing arrangements can be provided so as to connect the rotatable barrel 50.

In FIG. 2, it can be seen that the power source 62 can also be a pump. The addition to the power applied by the main shaft 42 is also supplied to the barrel 50 so as to drive the intermediate turbine blade stages. This results in a shorter piece of equipment and a better utilization of the power supplied by the power source.

In the prior art to the present inventor, attention was directed to a variety of turbines such as steam turbines, condensing turbines, gas compressors, and other forms of turbine. However, the prior art did not mention the use of the counter-rotating blades in association with a gas turbine. As such, the present inventor has directed efforts toward improving the efficiency of the gas turbine through the use of such counter-rotating blades.

It is an object the present invention to provide a gas turbine apparatus that utilizes a greater percentage of the energy of the working fluid.

It is another object of the present invention provide a gas turbine apparatus that can be used so as to power components or direct it back to primary driven equipment.

It is still another object of the present invention provide a gas turbine apparatus that is suitable for providing power to pumps, hydraulics and electrical generators.

These and other objects and advantages of the present invention will become apparent from a reading of the attached specification and appended claims.

### BRIEF SUMMARY OF THE INVENTION

The present invention is a gas turbine apparatus that comprises a main shaft, a first plurality of blades mounted to the main shaft, a second plurality of blades, a barrel affixed to the second plurality of blades, a fuel line opening to an interior of the barrel, and an igniter cooperative with the interior of the barrel and adapted to selectively ignite the fuel in the barrel. The first plurality of blades are in spaced relation to each other along the main shaft. The second plurality of blades are each interposed between adjacent blades of the first plurality of blades. The barrel is rotatable in a direction opposite to a direction of rotation of the main shaft or, in other words, the first set of blades rotates in a direction opposite to a direction of rotation of the second set of blades. The fuel line is adapted to pass a fuel into the interior of the barrel.

In an embodiment of the present invention, the main shaft has an interior passageway. The fuel line extends through this interior passageway. The fuel line has an end extending outwardly of the main shaft. This end is adapted to introduce fuel into the interior of the barrel. In an embodiment of the present invention, the end of the fuel line comprises a first end extending outwardly of one side of the main shaft and a second end extending outwardly of an opposite side of the main shaft.

The igniter can extend through the wall of the barrel so as to have an end in the interior of the barrel. Alternatively, the igniter can extend through or along the main shaft so as to have an end in the interior of the barrel.

A frame supports the main shaft above an underlying surface. This frame has a first set of bearings receiving a first portion of the main shaft at a location on one side of the first plurality of blades and a second set of bearings receiving a second portion of the shaft on an opposite side of the second plurality of blades. A first load is connected to the main shaft such that a rotation of the main shaft drives the first load. A second load is connected to the barrel such that a rotation of the barrel drives the second load. A power supply can be connected to the igniter so as to provide power to ignite the combustible fluids in the combustion chamber.

The first plurality of blades comprises an upstream set of blades affixed to the main shaft and a downstream set of blades affixed to the main shaft in spaced relation to the upstream set of blades. The combustion chamber is positioned in the space between the upstream set of blades and the downstream set of blades. The fuel line opens to the space between the upstream set of blades and the downstream set of blades. The second plurality of blades includes an upstream set of blades interposed between blades of the upstream set of blades of the first plurality of blades and a downstream set of blades interposed between blades of the downstream set of blades of the first plurality of blades.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a cross-sectional view showing a turbine with counter-rotating blades of an embodiment of the prior art.

FIG. 2 is a cross-sectional view of an alternative embodiment of a turbine with counter-rotating blades of the prior art.

FIG. 3 is a cross-sectional view showing the gas turbine apparatus in accordance with the present invention.

FIG. 4 is an end view of the gas turbine apparatus of the present invention.

### DETAILED DESCRIPTION OF THE INVENTION

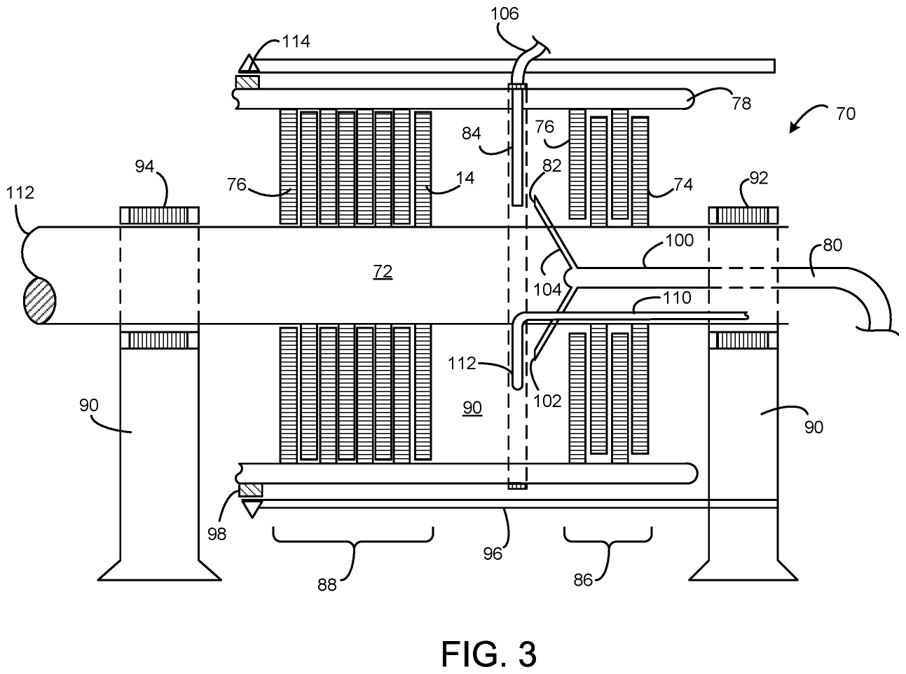

Referring to FIG. 3, there is shown the gas turbine apparatus 70 in accordance with the present invention. The gas turbine apparatus 70 includes a main shaft 72, a plurality of blades 74 mounted to the main shaft 72, a second plurality of blades 74 each interposed between adjacent blades of the second plurality of blades 76. The second plurality of blades are each interposed between adjacent blades of the first plurality of blades 74. A barrel 78 is affixed to the second plurality of blades 76. A fuel line 80 has an end 82 opening to the interior of the barrel 78. An igniter 84 is cooperative with the interior of the barrel 78 and is adapted to selectively ignite a fuel as released or introduced by the fuel line 80 into the barrel 78. The barrel 78 rotates in a direction opposite to the direction of rotation of the shaft 72 or, in other words, the first set of blades 74 rotates in a direction opposite the direction of rotation of the second set of blades 76.

As can be seen in FIG. 3, there is an upstream set of blades 86 and a downstream set of blades 88 with a space 90 therebetween. The end 82 of the fuel line 80 will open to the space 90. The space 90 is the combustion chamber of the gas turbine apparatus 70. The igniter 84 is located in space 90.

The frame 90 supports the main shaft 72 and also can support the barrel 78. The main shaft 72 has a first set of bearings 92 that receive a portion of the main shaft 72 on the side of the upstream set of blades 86. There is another set of bearings 94 that is fitted to the frame 90 and located on the downstream side of the downstream set of blades 88. The barrel 78 is supported by an arm 96. It can be seen that arm 96 extends outwardly so as to have suitable bearings 98 supporting the barrel 78 in the desired position. Other supports can also be used so as to rotatably support the barrel 78.

In the embodiment shown in FIG. 3, can be seen that the fuel line 80 extends through an interior passageway 100 within the main shaft 72. In one embodiment the present invention, there is a single and 82 which serves to release fuel into the space 90. However, as illustrated in FIG. 3, there is another end 102 that also releases fuel into the space 90. End 82 is on opposite side of the main shaft 72 from the end 102. This Y-shaped channel 104 serves to distribute fuel more evenly within the space 90. Since the shaft 72 will be rapidly spinning, the fuel is rapidly dispersed and aerosolized in the space 90 prior to ignition by the igniter 84.

FIG. 3 shows the igniters 84 extending through a wall of the barrel 78. Lines 106 can connect to a power supply so that power is delivered to the igniters 84 as desired. An alternative embodiment of the igniter is also shown by igniters 110. Igniters 110 can extend through the main shaft 72 or on the exterior of the main shaft 72. Ultimately, igniters 110 will have an end 112 located in space 90. As such, in any embodiment, the igniters are used to properly ignite the gaseous fuel for the purposes of operating the gas turbine 70 of the present invention.

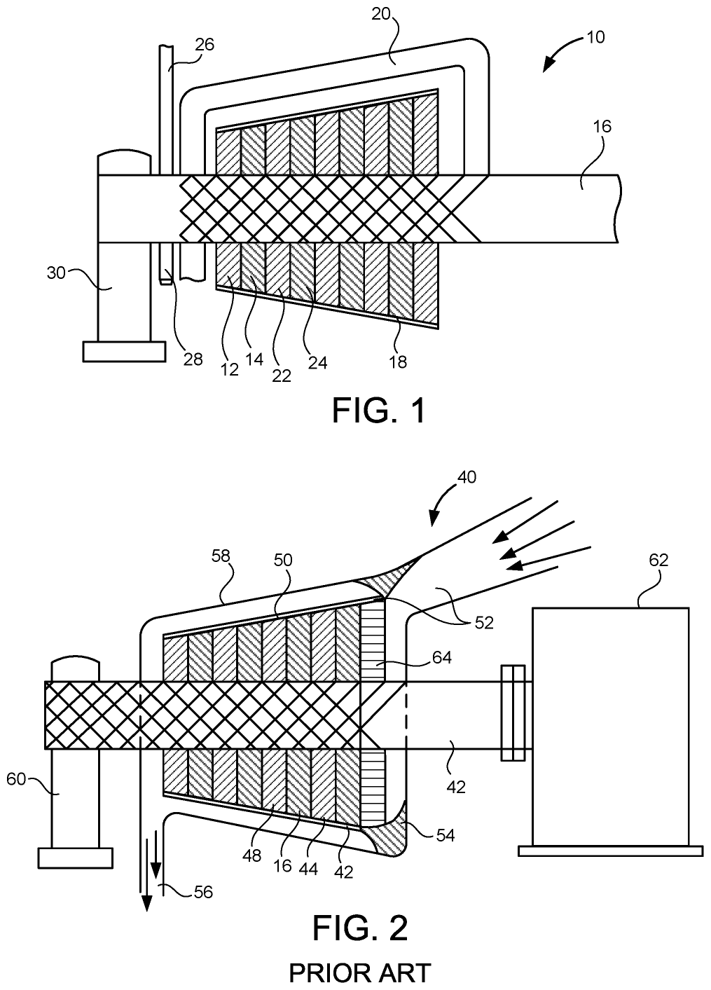

Since it is desirable to extract work from the gas turbine 70, the main shaft 72 can have its end 112 connected to a driven load (such as shown in FIGS. 1 and 2 herein). Similarly, the driven barrel 78 can be connected to a load 114 such that the rotational motion of the barrel 78 drives the load 114. The loads can be of various types, such as described hereinbefore.

The turbine apparatus 70 of the present invention serves to free those blades that would be fixed to a stationary member of a conventional gas turbine apparatus. As such, these free blades are available to produce work. This results in a rotation in an opposite direction to the primary blades. The energy that would be captured by attaching blades to a segment or to the barrel which would be allowed to move. As such, previously lost energy is now captured. The barrels can be attached such that the energy can be collected in a manner that can be harnessed. As such the barrel 78, as shown in FIG. 3, can be made up of a plurality of separate segments that are interconnected together. The resulting energy can be used to power other components or directed back to the primary-driven equipment.

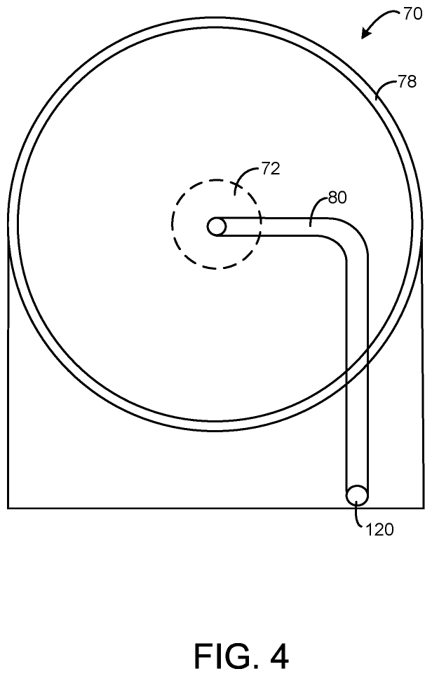

FIG. 4 is an end view of the gas turbine apparatus 70 of the present invention. In particular, the barrel 78 is illustrated as of a circular configuration. The fuel line 80 will extend through the interior of the main shaft 72 so as to supply fuel to the space between the upstream and downstream sets of blades. An inlet 120 can be used as connect to a supply of fuel to be delivered into the interior of the gas turbine apparatus 70.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A gas turbine apparatus comprising:
a main shaft;
a first plurality of blades mounted to said main shaft, said first plurality of blades being in spaced relation to each other along said main shaft;
a second plurality of blades each be interposed between adjacent blades of said first plurality of blades;
a barrel affixed to said second plurality of blades, said barrel rotatable in a direction opposite to a direction of rotation of said main shaft;
a fuel line opening to an interior of said barrel, said fuel line adapted to pass a fuel into the interior of said barrel; and
an igniter cooperative with the interior of said barrel and adapted to selectively ignite the fuel in said barrel.

2. The gas turbine apparatus of claim 1, said main shaft having an interior passageway, said fuel line extending through said interior passageway.

3. The gas turbine apparatus of claim 2, said fuel line having an end extending outwardly of said main shaft, the end of said fuel line adapted to introduce the fuel into the interior of said barrel.

4. The gas turbine apparatus of claim 3, the end of said fuel line comprising a first end extending outwardly of one side of said main shaft and a second end extending outwardly of an opposite end of said main shaft.

5. The gas turbine apparatus of claim 1, said igniter extending through a wall of said barrel so as to have an ignition end in the interior of said barrel.

6. The gas turbine apparatus of claim 1, said igniter extending through or along said main shaft so as to have an ignition end in the interior of said barrel.

7. The gas turbine apparatus of claim 1, further comprising:
a frame supporting said main shaft above an underlying surface, said frame having a first set of bearings receiving a first portion of said main shaft at a location on one side of said first plurality of blades and a second set of bearings receiving a second portion of said shaft on an opposite side of said second plurality of blades.

8. The gas turbine apparatus of claim 1, further comprising:
a first load connected to said main shaft such that a rotation of said main shaft drives said first load.

9. The gas turbine apparatus of claim 8, further comprising:
a second load connected to said barrel such that a rotation of said barrel drives said second load.

10. The gas turbine apparatus of claim 1, further comprising:
a power supply connected to said igniter so as to provide power to ignite said igniter.

11. The gas turbine apparatus of claim 1, said first plurality of blades comprising:
an upstream set of blades affixed to said main shaft; and
a downstream set of blades affixed to said main shaft in spaced relation to said upstream set of blades.

12. The gas turbine apparatus of claim 11, said igniter positioned in a space between said upstream set of blades and said downstream set of blades.

13. The gas turbine apparatus of claim 12, said fuel line opening to the space between said upstream set of blades and said downstream set of blades.

14. The gas turbine apparatus of claim 13, said second plurality of blades comprising:
an upstream set of blades interposed between blades of said upstream set of blades of said first plurality of blades; and
a downstream set of blades interposed between blades of said downstream set of blades of said first plurality of blades.

15. A gas turbine apparatus comprising:
a main shaft;
a first plurality of blades mounted to said main shaft, said first plurality blades being in spaced relation to each other along said main shaft;
a second plurality of blades each interposed between adjacent blades of said first plurality of blades;
a barrel affixed to said second plurality of blades, said second plurality of blades being rotatable in a direction opposite to a direction of rotation of said first plurality of blades;
a fuel line opening to an interior of said barrel, said fuel line adapted to pass a fuel into the interior of said barrel; and
an igniter cooperative with the interior of said barrel and adapted to selectively ignite the fuel in said barrel.

16. The gas turbine apparatus of claim 15, said first plurality of blades comprising:
an upstream set of blades affixed to said main shaft; and
a downstream set of blades affixed to said main shaft in spaced relation to said upstream set of blades.

17. The gas turbine apparatus of claim 16, said igniter positioned in a space between said upstream set of blades and said downstream set of blades.

18. The gas turbine apparatus of claim 17, said fuel line opening in the space between said upstream set of blades of said downstream set of blades.

19. The gas turbine apparatus of claim 18, said second plurality of blades comprising:
an upstream set of blades interposed between blades of said upstream set of blades of said first plurality of blades; and
a downstream set of blades interposed between blades of said downstream set of blades of said first plurality of blades.

20. The gas turbine apparatus of claim 15, said main shaft having an interior passageway, said fuel line extending through the interior passageway, said fuel line having an end extending outwardly of said main shaft, the end of said fuel line being adapted to introduce fuel into the interior of said barrel.
